(19) United States
(12) Patent Application Publication
(10) Pub. No.: US 2014/0345289 A1
(43) Pub. Date: Nov. 27, 2014

(54) GAS TURBOMACHINE COMBUSTOR ASSEMBLY INCLUDING A LIQUID FUEL START-UP SYSTEM

(71) Applicant: Borys Borysovich Shershnyov, Moscow (RU)

(72) Inventor: Borys Borysovich Shershnyov, Moscow (RU)

(73) Assignee: General Electric Company, Schenectady, NY (US)

(21) Appl. No.: 13/984,923

(22) PCT Filed: Feb. 1, 2012
(86) PCT No.: PCT/RU12/00051

§ 371 Date: Aug. 12, 2013

(51) Int. Cl. F02C 9/40; F23K 5/12; F23R 3/36

(52) U.S. Cl. CPC F02C 9/40; F23R 3/36; F23K 5/12; F23K 2301/103
USPC 60/772; 60/39.463

(57) ABSTRACT

A turbomachine combustor assembly includes a combustor body, a combustion chamber defined within the combustor body, one or more combustion nozzles positioned to direct a combustible fluid into the combustion chamber, and a fuel start-up system fluidly connected to the combustion chamber. The fuel start-up system is configured and disposed to combine a liquid fuel and a combustible gas to form an ignition fuel. A pilot nozzle is fluidly connected to the fuel start-up system. The pilot nozzle is configured and disposed to deliver an atomized cloud of the ignition fuel toward the combustion chamber.

### CROSS REFERENCE TO RELATED APPLICATION

This is a National Stage Application claiming priority to PCT Application No. PCT/RU2012/000051 filed Feb. 1, 2012, the entire contents of which are incorporated herein by reference.

### BACKGROUND OF THE INVENTION

The subject matter disclosed herein relates to the art of turbomachines and, more particularly, to a gas turbomachine combustor assembly including a fuel start-up system.

Turbomachines include a casing that houses a turbine. The turbine includes a plurality of blades or buckets that extend along a gas path. The buckets are supported by a number of turbine rotors that define a plurality of turbine stages. A combustor assembly generates hot gases that are passed through a transition piece toward the plurality of turbine stages. In addition to hot gases from the combustor assembly, gases at a lower temperature flow from a compressor toward a wheelspace of the turbine. The lower temperature gases provide cooling for the rotors as well as other internal components of the turbine.

The combustor assembly generally includes one or more combustion nozzles that directed a combustible fluid into a combustion chamber. The combustible fluid is initially ignited by a pilot nozzle arranged near the one or more combustion nozzles. The pilot nozzle introduces a pilot fuel into the combustion chamber localized near outlets of the combustion nozzles. The pilot fuel is ignited to create a flame front that elevates a temperature of the combustion chamber and ignites the combustible fluid passing from the combustion nozzles.

### BRIEF DESCRIPTION OF THE INVENTION

According to an aspect of the exemplary embodiment, a turbomachine combustor assembly includes a combustor body, a combustion chamber defined within the combustor body, one or more combustion nozzles positioned to direct a combustible fluid into the combustion chamber, and a fuel start-up system fluidly connected to the combustion chamber. The fuel start-up system is configured and disposed to combine a liquid fuel and a combustible gas to form an ignition fuel. A pilot nozzle is fluidly connected to the fuel start-up system. The pilot nozzle is configured and disposed to atomize the ignition fuel and deliver an atomized cloud of the ignition fuel toward the combustion chamber.

According to another aspect of the exemplary embodiment, a method of delivering an atomized pilot fuel into a turbomachine combustion chamber includes introducing a liquid fuel into an start fuel vessel, introducing a combustible gas into the start fuel vessel, combining the liquid fuel and the combustible gas in the start fuel vessel to form a liquid ignition fuel, passing the liquid ignition fuel to a pilot nozzle, and discharging an atomized cloud of the liquid ignition fuel from the pilot nozzle into the combustion chamber.

According to yet another aspect of the exemplary embodiment, a turbomachine includes a compressor portion, a turbine portion mechanically linked to the compressor portion, and a combustor assembly including a combustor body, a combustion chamber defined within the combustor body, one or more combustion nozzles positioned to direct a combustible fluid into the combustion chamber, and a fuel start-up system fluidly connected to the combustion chamber. The fuel start-up system is configured and disposed to combine a liquid fuel and a combustible gas to form an ignition fuel. A pilot nozzle is fluidly connected to the fuel start-up system. The pilot nozzle is configured and disposed to atomize the ignition fuel and deliver an atomized cloud of the ignition fuel toward the combustion chamber.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a combustor assembly having a liquid fuel start-up system in accordance with an exemplary embodiment;

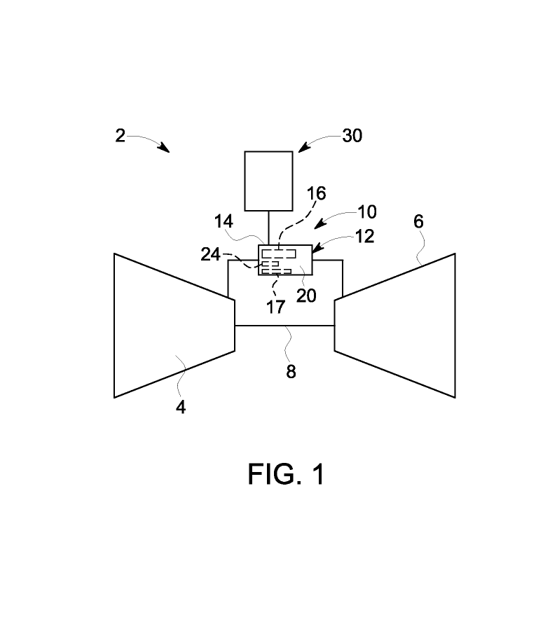

FIG. 2 is a schematic view of the liquid fuel start-up system in accordance with the exemplary embodiment; and

FIG. 3 is a graph illustrating solubility of methane in liquid diesel fuel.

The detailed description explains embodiments of the invention, together with advantages and features, by way of example with reference to the drawings.

### DETAILED DESCRIPTION OF THE INVENTION

A turbomachine in accordance with an exemplary embodiment is indicated generally at 2. Turbomachine 2 includes a compressor portion 4 mechanically linked to a turbine portion 6 through a common compressor/turbine shaft 8. A combustor assembly 10 is fluidly connected to compressor portion 4 and turbine portion 6. Combustor assembly 10 is formed from a plurality of circumferentially spaced combustors, one of which is indicated at 12. Of course it should be understood that combustor assembly 10 could include other arrangements of combustors. Combustor assembly 12 includes a combustor body 14 within which are housed a plurality of combustion nozzles, two of which are indicated at 16 and 17, and a combustion chamber 20. Combustor assembly 10 is also shown to include a pilot nozzle 24 arranged adjacent to combustion nozzles 16 and 17. It should be understood that pilot nozzle 24 could be integrated into, for example, one of the plurality of combustion nozzles.

With this arrangement, compressor portion 4 delivers compressed air to combustor assembly 10. The compressed air mixes with a combustible fluid to form a combustible mixture. The combustible mixture is passed from first and second combustion nozzles 16 and 17 and combusted in combustion chamber 20 to form products of combustion. The products of combustion are delivered to turbine portion 6 through a transition piece (not shown). The products of combustion expand through turbine portion 6 to power, for example, a generator, a pump, an aircraft or the like (also not shown). During start up, the combustible mixture is ignited by an ignition fuel passing from pilot nozzle 24 as will be discussed more fully below.

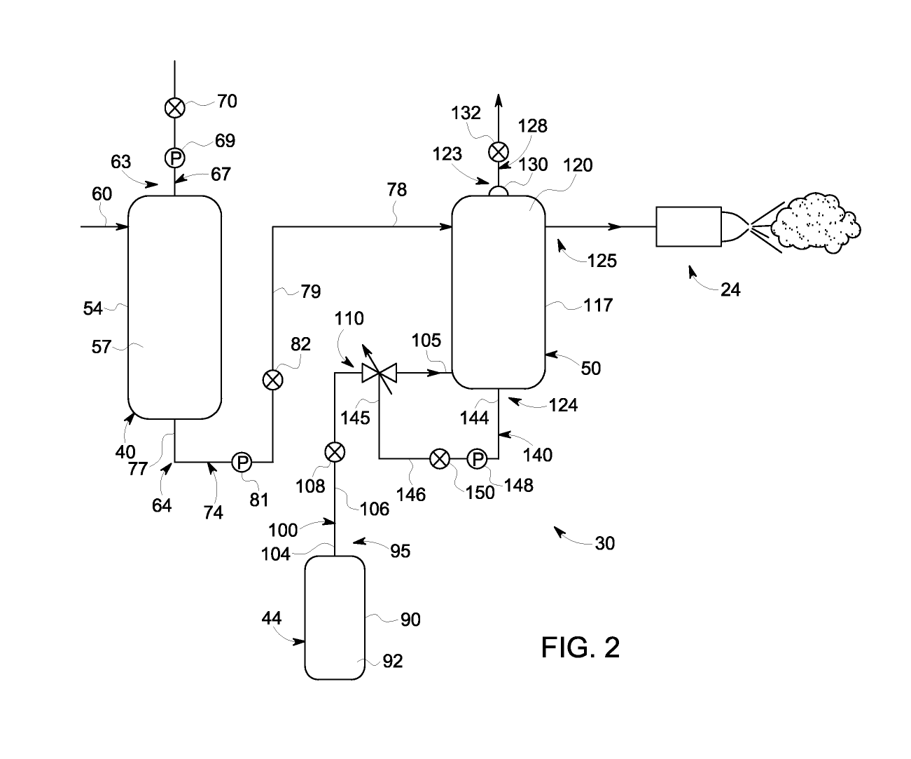

In accordance with an exemplary embodiment, turbomachine 2 includes a liquid fuel start-up fuel start-up system liquid fuel start-up system 30 that produces an atomized cloud of fuel from pilot nozzle 24 to enhance ignition. As best shown in FIG. 2, fuel start-up system liquid fuel start-up system 30 includes a liquid fuel vessel 40 and a combustible gas vessel 44 fluidly connected to an start fuel vessel 50. Liquid fuel vessel 40 defines a deaerator 54 having an interior zone 57. Deaerator 54 includes an inlet 60 for receiving liquid fuel such as diesel fuel (DF), a first outlet portion 63, and a second outlet portion 64. First outlet portion 63 constitutes an evacuation port 67 having a vacuum pump 69 and a one-way valve 70. Vacuum pump 69 is selectively activated to purge air from deaerator 54 with one-way valve 70 preventing back flow. Second outlet portion 64 defines a fluid delivery conduit 74 that guides liquid fuel to start fuel vessel 50. Fuel delivery conduit 74 includes a first end 77 coupled to deaerator 54, a second end 78 coupled to start fuel vessel 50, and an intermediate section 79. Intermediate section 79 includes a fuel pump 81 and a one-way valve 82. Fuel pump 81 urges liquid fuel from deaerator 54 with one-way valve 82 preventing backflow from start fuel vessel 50.

In further accordance with the exemplary embodiment, combustible gas vessel 44 constitutes a pressure vessel 90 having an interior 92 that is configured to store a combustible gas such as methane (CH₄) or Hydrogen (H). Pressure vessel 90 includes an outlet section 95 that is coupled to a gas supply conduit 100. Gas supply conduit 100 fluidly connects pressure vessel 90 with start fuel vessel 50. Gas supply conduit 100 includes a first end portion 104 that extends from outlet section 95, a second end portion 105 that fluidly connects with start fuel vessel 50, and an intermediate portion 106. Intermediate portion 106 includes a one-way valve 108 that prevents a back flow of combustible gas to pressure vessel 90, and a throttling valve 110 that provides a flow restriction in intermediate portion 106. As will be discussed more fully below, throttling valve 110 constitutes a first saturated stage mixer of liquid fuel start-up fuel start-up system liquid fuel start-up system 30.

In still further accordance with the exemplary embodiment, start fuel vessel 50 takes the form of a bubbler 117 having an interior section 120 within which is combined liquid fuel and combustible gas to form a saturated ignition fuel. Thus, bubbler 117 constitutes a second saturated stage mixer of fuel start-up system liquid fuel start-up system 30. Bubbler 117 includes a first outlet 123, a second outlet 124, and a third outlet 125. First outlet 123 is coupled to a pressure relief system 128 including an expansion dome 130 and a one-way valve 132. Expansion dome 130 collects undissolved combustible gas to reduce contact between liquid fuel and air, supports desired pressure levels within start fuel vessel 50, and provides a pressure relief function that allows combustible gas to escape from start fuel vessel 50 in the event internal pressures exceed desired parameters. Second outlet 124 is coupled to a recirculation conduit 140. Recirculation conduit 140 includes a first end section 144 coupled to second outlet 124, a second end section coupled to throttling valve 110, and an intermediate zone 146. Intermediate zone 146 includes a pump 148 and a one-way valve 150. One-way valve 150 prevents back flow into bubbler 117. Pump 148 guides a portion of the liquid fuel in bubbler 117 to throttling valve 110 to mix with combustible gas to begin the first saturated stage. Additional saturation occurs within bubbler 117 such that the ignition fuel constitutes a liquid fuel fully saturated with combustible gas.

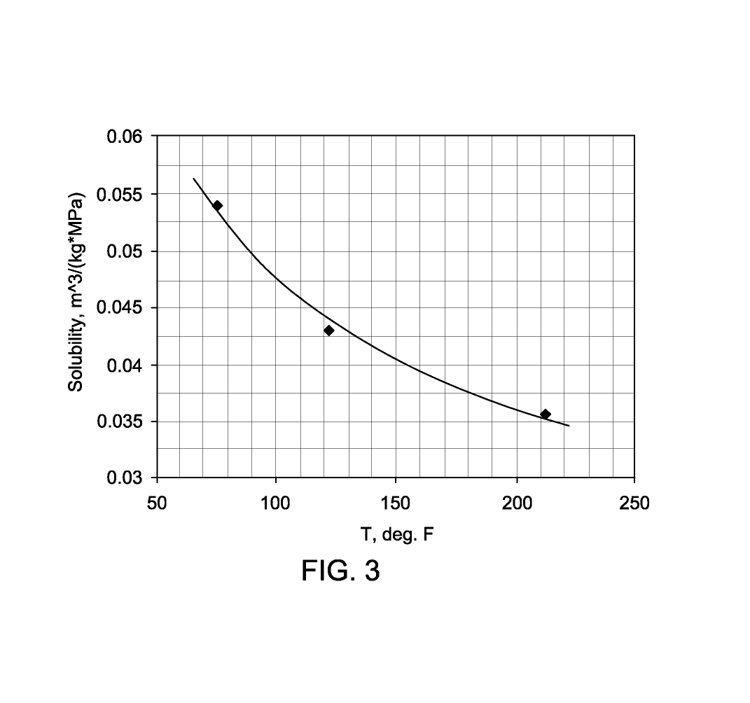

Third outlet 125 leads from bubbler 117 to pilot nozzle 24. During start up of turbomachine 2, ignition liquid fuel is delivered from bubbler 117 to pilot nozzle 24. Upon exiting pilot nozzle 24, the ignition fuel atomizes as a result of nozzle geometry and effervescence that occurs as the combustible gas is freed from the liquid fuel. This two stage atomization provides an atomized cloud of ignition fuel that is readily ignited particularly at lower ambient temperatures. As best shown in FIG. 3, solubility of CH₄ in DF increases as temperatures decrease. Thus, in lower temperatures, the ignition fuel in accordance with the exemplary embodiment will contain a greater amount of CH₄ and thus will ignite more readily. The atomized cloud of ignition fuel is ignited and passes into combustion chamber 20 to not only provide an ignition source from combustible gases flowing from combustion nozzles 16 and 17, but also provide an initial pre-heat to combustion chamber 20 to improve an overall combustion effect during start up, in particular during low temperature start up.

At this point it should be understood that while described in terms of DF and CH₄ or methane, other types of liquid fuels and/or combustible gases can be employed depending upon desired combustion chemistries. Also, while described as being particularly effective during cold starts at lower temperatures, the fuel start-up system in accordance with the exemplary embodiment can be employed at various starting conditions across a broad range of ambient temperature conditions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine combustor assembly comprising:
a combustor body;
a combustion chamber defined within the combustor body;
one or more combustion nozzles positioned to direct a combustible fluid into the combustion chamber;
a fuel start-up system fluidly connected to the combustion chamber, the fuel start-up system being configured and disposed to combine a liquid fuel and a combustible gas to form an ignition fuel; and
a pilot nozzle fluidly connected to the fuel start-up system, the pilot nozzle being configured and disposed to atomize the ignition fuel and deliver an atomized cloud of the ignition fuel toward the combustion chamber.

2. The turbomachine combustor assembly according to claim 1, wherein the liquid fuel is saturated with combustible gas.

3. The turbomachine combustor assembly according to claim 1, wherein the fuel start-up system includes a liquid fuel vessel, a combustible gas vessel, and an start fuel vessel, each of the liquid fuel vessel and combustible fuel vessel being fluidly connected to the start fuel vessel.

4. The turbomachine combustor assembly according to claim 3, further comprising: a throttling valve fluidly connected between the combustible gas vessel and the start fuel vessel.

5. The turbomachine combustor assembly according to claim 4, wherein the start fuel vessel includes a first outlet fluidly connected to the pilot nozzle and a second outlet fluidly connected to the throttling valve.

6. The turbomachine combustor assembly according to claim 1, wherein the liquid fuel comprises diesel fuel.

7. The turbomachine combustor assembly according to claim 1, wherein the combustible gas comprises one of methane and hydrogen.

8. A method of delivering an atomized pilot fuel into a turbomachine combustion chamber, the method comprising:
introducing a liquid fuel into an start fuel vessel;
introducing a combustible gas into the start fuel vessel;
combining the liquid fuel and the combustible gas in the start fuel vessel to form a liquid ignition fuel;
passing the liquid ignition fuel to a pilot nozzle; and
discharging an atomized cloud of the liquid ignition fuel from the pilot nozzle into the combustion chamber.

9. The method of claim 8, further comprising: saturating the liquid fuel with the combustible gas in the start fuel vessel.

10. The method of claim 8, further comprising: passing the combustible gas through a throttling valve arranged downstream of the start fuel vessel.

11. The method of claim 10, further comprising: recirculating a portion of the liquid ignition fuel from the start fuel vessel, through the throttling valve, and back to the start fuel vessel.

12. The method of claim 8, wherein discharging the atomized cloud of the liquid ignition fuel from the pilot nozzle includes effervescing the combustible gas from the liquid fuel.

13. The method of claim 8, wherein combining the liquid fuel and the combustible gas includes combining at least one of a methane gas and a hydrogen gas with liquid diesel fuel.

14. A turbomachine comprising:
a compressor portion;
a turbine portion mechanically linked to the compressor portion; and
a combustor assembly including a combustor body, a combustion chamber defined within the combustor body, one or more combustion nozzles positioned to direct a combustible fluid into the combustion chamber, a fuel start-up system fluidly connected to the combustion chamber, the fuel start-up system being configured and disposed to combine a liquid fuel and a combustible gas to form an ignition fuel, and a pilot nozzle fluidly connected to the fuel start-up system, the pilot nozzle being configured and disposed to atomize the ignition fuel and deliver an atomized cloud of the ignition fuel toward the combustion chamber.

15. The turbomachine according to claim 14, wherein the fuel start-up system includes a liquid fuel vessel, a combustible gas vessel, and an start fuel vessel, each of the liquid fuel vessel and combustible fuel vessel being fluidly connected to the start fuel vessel.

16. The turbomachine according to claim 15, further comprising: a throttling valve fluidly connected between the combustible gas vessel and the start fuel vessel.

17. The turbomachine according to claim 16, wherein the start fuel vessel includes a first outlet fluidly connected to the pilot nozzle and a second outlet fluidly connected to the throttling valve.

18. The turbomachine according to claim 14, wherein the liquid fuel comprises diesel fuel.

19. The turbomachine according to claim 14, wherein the combustible gas comprises one of methane and hydrogen.

20. The turbomachine according to claim 14, wherein the liquid fuel is saturated with combustible gas.
